(19) United States
(12) Patent Application Publication
(10) Pub. No.: US 2021/0028472 A1
(43) Pub. Date: Jan. 28, 2021

(54) Similar Principle Analysis Method of Input and Output Characteristics for Fuel Cell

(71) Applicant: Xi?an Jiaotong University, Xi'an (CN)

(72) Inventors: Wenquan TAO, Xi'an (CN); Le LEI, Xi'an (CN); Fan BAI, Xi'an (CN); Li CHEN, Xi'an (CN); Lei CHEN, Xi'an (CN); Zhiguo QU, Xi'an (CN)

(21) Appl. No.: 16/939,034

(22) Filed: Jul. 26, 2020

(30) Foreign Application Priority Data
Jul. 26, 2019 (CN) 201910681572.3

(51) Int. Cl. H01M 8/04298; G06F 30/10

(52) U.S. Cl. CPC H01M 8/04305; H01M 2008/1095; G06F 30/10

(57) ABSTRACT

Analysis method of fuel cell input and output characteristics, which utilizes π theorem and principle of similarity to carry out dimensional analysis and equation analysis for model parameters and governing equations respectively for a given proton exchange membrane fuel cell theoretical model, includes the steps: determine model parameters and dimensions of each parameter, and filter out basic parameters for dimensional analysis; use π theorem to perform dimensional analysis to obtain dimensionless numbers; use principle of similarity to analyze model governing equations to obtain dimensionless numbers; compare the two sets of dimensionless numbers to determine the dimensionless number of the fuel cell model under study; define dimensionless voltage and dimensionless current to serve as the ordinate and abscissa of the dimensionless polarization curve, then any point on the dimensionless polarization curve represents a set of similar working conditions and the number and time of experiment or simulation can be greatly reduced.

### BACKGROUND OF THE PRESENT INVENTION

### Field of Invention

The present invention relates to the field of new energy, and particularly to a similarity principle analysis method of fuel cell input and output characteristics.

### Description of Related Arts

Proton exchange membrane fuel cells use hydrogen as fuels. Under the condition of no combustion reaction, the chemical energy of the reactants can be converted into electrical energy and the product is water only. Therefore, it is a very promising clean energy device. At the same time, its advantages such as no pollution, low noise, and high efficiency make it gradually become a strong competitor for the power source of future energy installations. The output characteristics of fuel cells are affected by dozens of parameters. According to the conventional experimental methods, even if each variable only changes twice and other parameters remain unchanged, at least hundreds of millions of experiments are required. This experimental design method is obviously not practical. How to reduce the number of experiments on a large scale and at the same time to obtain a general rule has become a problem from fuel cell scientific research to engineering applications.

Since Ticianelli and others first proposed the polarization curve of the proton exchange membrane fuel cell in 1988, there have been more than 100,000 papers on fuel cells and more than 20,000 papers on proton exchange membrane fuel cell. All of the literature uses the polarization curve to describe the output characteristics of proton exchange membrane fuel cell. However, the horizontal and vertical coordinates of the polarization curve are represented by dimensional physical quantities, which lacks universality.

### SUMMARY OF THE PRESENT INVENTION

In order to overcome the above problems, an object of the present invention is to provide a similarity principle analysis method of input and output characteristics for fuel cell. Through this analysis method, a dimensionless polarization curve can be obtained. By changing the quantity of components of the obtained dimensionless numbers but keeping the values of the dimensionless numbers unchange, the correction of the derived dimensionless numbers can be verified. Each point in the dimensionless polarization curve represents a similar set of working conditions. In this way, the number of experiment and the amount of experiment time can be greatly reduced in the experiment stage, and the cost saving effect can be achieved.

In order to achieve the above objective, the technical solution of the present invention is:

An analysis method of input and output characteristics of a proton exchange membrane fuel cell, which utilizes π theorem and the principle of similarity to respectively carry out dimensional analysis of model parameters and equation analysis of governing equations for a theoretical model of the proton exchange membrane fuel cell, which comprises the steps of:

(a) determining the model parameters of the theoretical model, wherein the model parameters include the geometric structure parameters, the physical parameters and the working condition parameters;

(b) determining dimensions of each of the model parameters of the model and filtering out basic parameters for implementing dimensional analysis;

(c) using π theorem to implementing dimensional analysis for the model parameters to obtain a first set of dimensionless numbers;

(d) using the principle of similarity to implement equation analysis for the governing equations of the theoretical model to obtain a second set of dimensionless numbers, wherein the governing equations of the theoretical model includes a mass equation, a momentum equation, a component equation, an electric potential equation and an ionic potential equation;

(e) comparing the first set of dimensionless numbers and the second set of dimensionless numbers, processing combination of dimensionless numbers for one of the two sets if needed, determining a relationship between the first and the second sets of dimensionless numbers and verifying an identity of the first and the second sets of dimensionless numbers, and finally determining dimensionless numbers of the theoretical model of the proton exchange membrane fuel cell; and

(f) defining a dimensionless voltage and a dimensionless current density for the theoretical model to obtain a dimensionless polarization curve for the theoretical model of the proton exchange membrane fuel cell.

Each dimensionless polarization curve obtained under the condition that the quantity of each component of the dimensionless number changes and the dimensionless number remains unchanged is completely coincident.

The theoretical model is a single phase isothermal model of parallel flow channel.

The geometric structure parameters comprise: a dimensional parameter of a characteristic length l of which a unit is m, and a dimensionless parameter of a porosity ε;

the physical parameters comprise: dimensional parameters of density ρ, viscosity μ, permeability K, gas diffusion coefficient D, Faraday constant divided by gas constant F/R of which the units are kg/m³, Pa·s, m², m²s⁻¹, and (C·K)/J respectively; and a dimensionless parameter of the Henry's constant H; and

the working condition parameters comprises: dimensional parameters of speed u, temperature T, concentration c, electric potential ϕ, and pressure p, and their units are m/s, K, mol/m⁻³, V, and Pa respectively; and dimensionless parameters of water conversion Coefficient β, cathode transfer coefficient α, stoichiometric ratio St, and mass fraction ω.

In the step (a), the model parameters further comprise combined parameters, the combined parameters are variables which usually appear in combination as one parameter for processing dimensional analysis.

The combined parameters include Faraday constant divided by specific surface area and reference exchange current density F/(Aₛj⁰), conductivity times mole fraction divided by the specific surface area and the reference exchange current density σM/(Aₛj⁰), and their units are m³·s/mol and kg/(V·mol·m²) respectively.

In the step (b), the dimensions of each of the model parameters are determined as: DIM(L)=L, DIM(ρ)=ML⁻³, DIM(u)=LT⁻¹, DIM(T)=θ, DIM(c)=NL⁻³ , DIM(ϕ)=ML²T⁻³I⁻¹, DIM(p)=L⁻¹MT⁻² , DIM(μ)=L⁻¹MT⁻¹, DIM(K)=L², DIM(D)=L²T⁻¹, DIM(F/R)=L⁻²M⁻¹T³ΘI, DIM(F/(Aₛj⁰)=L³TN⁻¹, DIM(σM/(Aₛj⁰))=M⁻²T³IN⁻¹; and

the filtered basic parameters are: characteristic length L, gas density ρ, gas velocity u, temperature T, gas concentration c, and electric potential ϕ;

in the step (c), the first set of dimensionless numbers obtained are:

$${π}_{1} = \frac{p}{ρ {u}^{2}} , {π}_{2} = \frac{μ}{ρ u l} , {π}_{3} = \frac{K}{{l}^{2}} , \\ {π}_{4} = ( \frac{F}{R} ) \frac{φ}{T} , {π}_{5} = \frac{D}{u l} , {π}_{6} = ( \frac{F}{{A}_{s} j} ) \frac{u c}{l} , and {π}_{7} = ( \frac{σ M}{{A}_{s} j} ) \frac{c φ}{{l}^{2} ρ} ;$$

in the step (d), the governing equations are as follows:

the mass equation is:

$$\frac{\partial ( ρ {u}_{i} )}{\partial {x}_{i}} = {S}_{m} ,$$

the momentum equation is:

$$\frac{ρ}{{ɛ}^{2}} {u}_{i} \frac{\partial {u}_{j}}{\partial {x}_{i}} = - \frac{\partial p}{\partial {x}_{j}} + \frac{{μ}_{e}}{ɛ} \frac{\partial }{\partial {x}_{i}} ( \frac{\partial {u}_{j}}{\partial {x}_{i}} ) + {S}_{u , j} ,$$

the component equation is:

$${u}_{i} \frac{\partial {ρ}_{j}}{\partial {x}_{i}} = \frac{\partial }{\partial {x}_{i}} ( {D}_{i j , e f f} \frac{\partial {ρ}_{j}}{\partial {x}_{i}} ) + {S}_{j} , j = {H}_{2} , {O}_{2} , vapor ,$$

the electric potential equation is:

∇·(σₛ∇ϕₛ)+S_{ϕ,s}=0, and

the ionic potential equation is:

∇·(σₘ∇ϕₘ)+S_{ϕ,m}=0;

wherein the governing equations include a plurality of source terms as follows:

a mass source item: Sₘ=ΣᵢSᵢ, i=H₂, O₂, H₂O;

a momentum source item:

$${S}_{u , j} = - \frac{μ}{K} {u}_{j} ;$$

component source items:

$${S}_{H} = \{ \begin{matrix}- ( {i}_{a} \text{/} 2 F ) {M}_{H} , & Anode catalytic layer \\ 0 , & others\end{matrix} , \\ {S}_{O} = \{ \begin{matrix}- ( {i}_{c} \text{/} 4 F ) {M}_{O} , & Anode catalytic layer \\ 0 , & others\end{matrix} , \\ {S}_{vapor} = \{ \begin{matrix}- ( β {i}_{a} \text{/} F ) {M}_{H} , & Anode catalytic layer \\ [ ( 1 + 2 β ) {i}_{c} \text{/} 4 F ] {M}_{O} , & Cathode catalytic layer \\ 0 , & others\end{matrix} ;$$

an electric potential source item:

$${S}_{φ , s} = \{ \begin{matrix}- {i}_{a} , & Anode catalytic layer \\ {i}_{c} , & Cathode catalytic layer \\ 0 , & others\end{matrix} ; and$$

an ionic potential source item:

$${S}_{φ , m} = \{ \begin{matrix}{i}_{a} , & Anode catalytic layer \\ - {i}_{c} , & Cathode catalytic layer \\ 0 , & others\end{matrix} ,$$

wherein an anode current density is:

iₐ=Aₛj₀^{a}(c_{H}^{m}/c_{H,ref}^{m})^{1/2}[exp(αₐnₐFηₐ/RT)−exp(−α_{c}nₐFηₐ/RT)], and

a cathode current density is:

i_{c}=Aₛj₀^{c}(c_{O}^{m}/c_{O,ref}^{m})[−exp(αₐn_{c}Fηₐ/RT)+exp(−α_{c}n_{c}Fη_{c}/RT)],

where cᵢ^{m}=Hᵢρᵢ/Mᵢ;

in the above governing equations and source items, uᵢ is a component of a gas velocity in an i-direction; xᵢ is a coordinate component in the i-direction; uⱼ is a gas velocity component in an j-direction; xⱼ is a coordinate component in the j-direction; μₑ is an effective viscosity in porous media; ρⱼ is a density of component j; ρ is a gas density; D_{ij,}_{_{eff}} is an effective diffusion coefficient on the i coordinate direction of component j; σₛ is a solid phase conductivity; σₘ is a membrane conductivity; ϕₛ is an electric potential; ϕₘ is an ionic potential; μ is a gas viscosity; K is a permeability; M_{H}is a molar mass of hydrogen; M_{O} is a molar mass of oxygen; S_{H} is a hydrogen component source item; S_{O} is an oxygen component source item; Sᵥₐₚₒᵣ is a steam component source item; cᵢ^{m} is a concentration of component i in Nafion; Hᵢ is the Henry constant of component i; Mᵢ is a molar constant in component i; c_{H}^{m} is a concentration of hydrogen in Nafion; c_{H,ref}^{m} is a reference concentration of hydrogen in Nafion; c_{O}^{m} is an oxygen concentration in Nafion; c_{O,ref}^{m} is a reference oxygen concentration in Nafion; Aₛj⁰ₐ is an anode reference exchange current density times specific surface area; Aₛj⁰_{c} is a cathode reference exchange current density times specific surface area; nₐ a number of protons transferred by anode electrochemical reaction; n_{c} is a number of protons transferred by cathode electrochemical reaction; αₐ is an anode conversion factor; α_{c} is a cathode conversion factor; β is a water transfer rate; ηₐ is an anode overpotential; η_{c} is a cathode overpotential;

in the step (d), the second set of dimensionless numbers obtained are as follows:

$${\prod }_{1} = Re = \frac{ρ u l}{ɛ {μ}_{e}} , {\prod }_{2} = E u = \frac{{ɛ}^{2} Δ p}{ρ {u}^{2}} , \\ {\prod }_{3} = D a r = \frac{K {μ}_{e}}{ɛ {l}^{2} μ} = \frac{K {μ}_{r}}{ɛ {l}^{2}} , {\prod }_{4} = \frac{α n F η}{R T} , \\ {\prod }_{5} = Dam = \frac{{H}_{o}}{{n}_{i} F} \frac{{k}_{s , i} {A}_{s} {j}^{0} {}_{c}^{}{l}{}_{}^{2}}{{c}_{c , ref}^{m} D} , {\prod }_{6} = \frac{l u}{D} , \\ {\prod }_{7} = \frac{{M}_{O} {c}_{O , ref}^{m} {σ}_{i} {φ}_{i}}{{H}_{O} {A}_{s} {{j}^{0}}_{c} {ρ}_{O} {l}^{2}} ;$$

In the above dimensionless numbers: Re is a Reynolds number; μₑ is an effective viscosity in porous medium; Eu is an Euler number; Δp is a pressure drop; μᵣ is a relative viscosity of porous medium; α is a conversion factor; n is a number of protons transported by electrochemical reaction; H_{O} is Henry's constant of oxygen; k_{s,i} is a coefficient in a chemical equation; nᵢ is a number of electrons transferred per mole of reaction; σᵢ is an i-phase conductivity; ϕᵢ is an i-phase potential; ρ_{O} is a density of oxygen; and the remaining parameters are the same as above;

in the step (e), when the first set of dimensionless numbers and the second set of dimensionless numbers are not completely identical, compare the dimensionless numbers and obtain the relationship between the first and the second sets of dimensionless numbers; for the above situation, following relationships are obtained:

$${\prod }_{1} = \frac{1}{ɛ {μ}_{r} {π}_{2}} , {\prod }_{2} = {ɛ}^{2} {π}_{1} , {\prod }_{3} = \frac{{μ}_{r}}{ɛ} {π}_{3} , \\ {\prod }_{4} = α n {π}_{4} , {\prod }_{5} = \frac{{k}_{s , i} {H}_{O}}{{n}_{i} {π}_{5} {π}_{6}} , {\prod }_{6} = \frac{1}{{π}_{5}} , {\prod }_{7} = \frac{{π}_{7}}{{H}_{O}} ;$$

in the step (f), the dimensionless voltage and the dimensionless current density are defined as:

$$\overline{V} = \frac{{V}_{o c}}{{V}_{cell}} - 1 , {\overline{J}}_{cell} = \frac{{j}_{cell}}{{j}_{cell , 0}} , {j}_{cell , 0} = \frac{{H}_{O} {A}_{s} {j}_{0} {ρ}_{in , c} {L}_{t}}{{M}_{O} {c}_{O , ref}^{m}} ,$$

where V_{cell} is an output voltage, V_{OC} is an open circuit voltage, j_{cell} is an output current density, j_{cell,0} is a reference output current density, Lₜ is a distance between cathode and anode plate.

After the step (f), further executing the following step or steps of:

(g) changing a quantity of each of the components of the dimensionless number so that a value of the dimensionless numberchanges within a certain range, thereby obtaining a corresponding dimensionless polarization curve, wherein any point is not only a single experimental working condition, but represents a similar set of working conditions, hence the number of experiments and the experiment time are greatly reduced to achieve an effect of cost saving.

Or, the following steps can be executed:

(h) changing a quantity of each of the components of the dimensionless number so that the values of the dimensionless numbers are changed and the obtained dimensionless numbers are different from the originals, thereby proving the dimensionless polarization curve obtained can reflect an influence of operating conditions on fuel cell output characteristics.

Compared with the conventionaltechnology, the advantageous effects of the present invention are the followings:

When the value of each component of the dimensionless number changes while the dimensionless number remains unchanged, this casecorresponds to the same dimensionless polarization curve. This is when the seven dimensionless numbers Π₁, Π₂, Π₃, Π₄, Π₅, Π₆, Π₇) remain unchanged and the same dimensionless polarization curve is obtained, which is shown in FIG. 2 of the drawings. The different values of the quantity of components of the dimensionless numbers represent the different operating conditions of the fuel cell. For example, for a dimensionless number Π₁, the components are ρ, u, l, ε and μe. These five components are changed according to the experimental design. Each change represents an actual working condition (such as working condition 1, working condition 2, working condition 3, and working condition 4). But as long as the value of Π₁ remains unchanged, the same dimensionless polarization curve will be obtained. In actual engineering, when designing fuel cells, organizing experiments and processing numerical simulations, each dimensionless number can be calculated first. If the design condition satisfies that any one of the seven dimensionless numbers is unchanged, the experimental design conditions can be simplified and the number of experiment times can be reduced (that is, only one experiment is required for the unchanged dimensionless number). This has guiding significance for more efficient and systematic organization of experiments or simulations in engineering.

### BRIEF DESCRIPTION OF THE DRAWINGS

FIG. 1 illustrates a technical roadmap of the present invention.

FIG. 2 illustrates a schematic diagram of the dimensionless polarization curve of the present invention.

FIG. 3 illustrates the dimensionless polarization curve obtained under different working conditions and the values of the dimensionless numbers (Π₁, Π₂, Π₃, Π₄) remain unchanged.

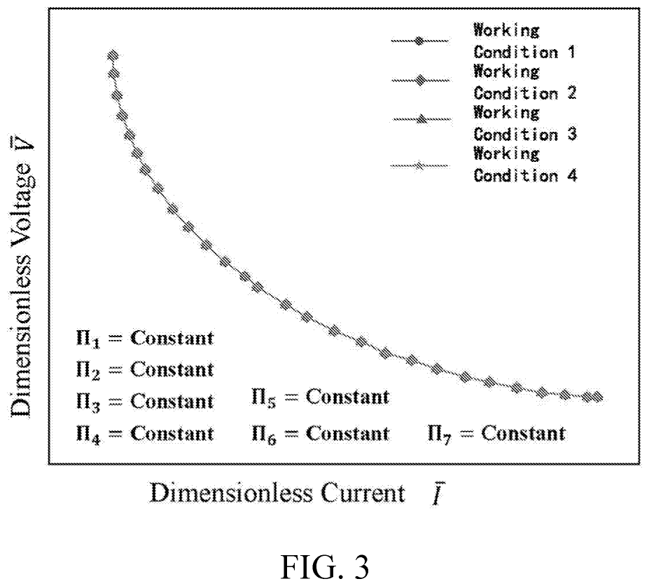

### DETAILED DESCRIPTION OF THE PREFERRED EMBODIMENT

The present invention is described in detail below with reference to the preferred embodiments and drawings.

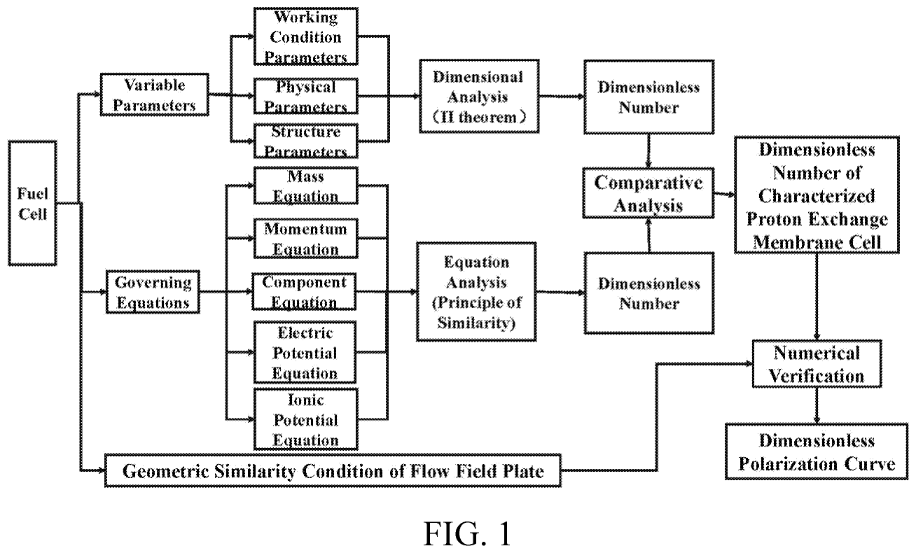

Referring to FIG. 1, a single isothermal model of a parallel flow channel of a proton exchange membrane fuel cell is used as an example for explanation. The method of the present invention is also applicable to other types of fuel cells and other fuel cell models, such as solid oxide fuel cells, non-isothermal models, and multiphase model.

According to a preferred embodiment of the present invention, the analysis method of the input and output characteristics of a fuel cell, executed by a processor of a computing machine, comprises the following steps:

(1) Determine the geometric structure parameters, physical property parameters, working condition parameters and related combination parameters of the theoretical model, as shown below:

Geometric structure parameters: the dimensional parameter is the characteristic length l, the unit is m, the dimensionless parameter is the porosity ε;

Physical parameters: the dimensional parameters are density ρ, viscosity μ, permeability K, gas diffusion coefficient D, Faraday constant divided by gas constant F/R, and their units are kg/m³, Pa·s, m², m²s⁻¹, (C·K)/J respectively, the dimensionless parameter is the Henry's constant H;

Working condition parameters: The dimensional parameters are speed u, temperature T, concentration c, electric potential ϕ, and pressure p, and their units are m/s, K, mol/m⁻³, V, and Pa respectively; and the dimensionless parameters are water conversion Coefficient β, cathode transfer coefficient α, stoichiometric ratio St, and mass fraction ω.

The combined parameters include the Faraday constant divided by the specific surface area and the reference exchange current density F/(Aₛj⁰), the conductivity times the mole fraction divided by the specific surface area and the reference exchange current density σM/(Aₛj⁰), and the units are m³·s/mol and kg/(V·mol·m²) respectively.

(2) Determine the dimensions of each parameters as follows: DIM(L)=L, DIM(ρ)=ML⁻³, DIM(u)=LT⁻¹, DIM(T)=θ, DIM(c)=NL⁻³, DIM(ϕ)=ML²T⁻³I⁻¹, DIM(p)=L⁻¹MT⁻², DIM(μ)=L⁻¹MT⁻¹, DIM(K)=L², DIM(D)=L²T⁻¹, DIM(F/R)=L⁻²M⁻¹T³ΘI, DIM(F/(Aₛj⁰))=L³TN⁻¹, DIM(σM/(Aₛj⁰))=M⁻²T³IN⁻¹; The basic parameters selected for dimensional analysis are: characteristic length L, gas density ρ, gas velocity u, temperature T, gas concentration C, and electric potential ϕ;

(3) Using π theorem for dimensional analysis, the dimensionless numbers obtained are:

$${π}_{1} = \frac{p}{ρ {u}^{2}} , {π}_{2} = \frac{μ}{ρ u l} , {π}_{3} = \frac{K}{{l}^{2}} , \\ {π}_{4} = ( \frac{F}{R} ) \frac{φ}{T} , {π}_{5} = \frac{D}{u l} , {π}_{6} = ( \frac{F}{{A}_{s} j} ) \frac{u c}{l} , and {π}_{7} = ( \frac{σ M}{{A}_{s} j} ) \frac{c φ}{{l}^{2} ρ} ;$$

(4) Analyzing the governing equations of the model using the equation analysis method to obtain dimensionless numbers;

the governing equations are as follows:

Mass equation:

$$\frac{\partial ( ρ {u}_{i} )}{\partial {x}_{i}} = {S}_{m} ;$$

Momentum equation:

$$\frac{ρ}{{ɛ}^{2}} {u}_{i} \frac{\partial {u}_{j}}{\partial {x}_{i}} = - \frac{\partial p}{\partial {x}_{j}} + \frac{{μ}_{e}}{ɛ} \frac{\partial }{\partial {x}_{i}} ( \frac{\partial {u}_{j}}{\partial {x}_{i}} ) + {S}_{u , j} ;$$

Component equation:

$${u}_{i} \frac{\partial {ρ}_{j}}{\partial {x}_{i}} = \frac{\partial }{\partial {x}_{i}} ( {D}_{i j , e f f} \frac{\partial {ρ}_{j}}{\partial {x}_{i}} ) + {S}_{j} , j = {H}_{2} , {O}_{2} , vapor ;$$

Electric potential equation:

∇·(σₛ∇ϕₛ)+S_{ϕ,s}=0;

Ionic potential equation:

∇·(σₘ∇ϕₘ)+S_{ϕ,m}=0;

The source terms of the governing equation are as follows:

Mass source item: Sₘ=ΣᵢSᵢ, i=H₂, O₂, H₂O;

momentum source item:

$${S}_{u , j} = - \frac{μ}{K} {u}_{j} ;$$

component source item:

$${S}_{H} = \{ \begin{matrix}- ( {i}_{a} \text{/} 2 F ) {M}_{H} , & Anode catalytic layer \\ 0 , & others\end{matrix} , \\ {S}_{O} = \{ \begin{matrix}- ( {i}_{c} \text{/} 4 F ) {M}_{O} , & Anode catalytic layer \\ 0 , & others\end{matrix} , \\ {S}_{vapor} = \{ \begin{matrix}- ( β {i}_{a} \text{/} F ) {M}_{H} , & Anode catalytic layer \\ [ ( 1 + 2 β ) {i}_{c} \text{/} 4 F ] {M}_{O} , & Cathode catalytic layer \\ 0 , & others\end{matrix} ;$$

electric potential source item:

$${S}_{φ , s} = \{ \begin{matrix}- {i}_{a} , & Anode catalytic layer \\ {i}_{c} , & Cathode catalytic layer \\ 0 , & others\end{matrix} ;$$

ionic potential source item:

$${S}_{φ , m} = \{ \begin{matrix}{i}_{a} , & Anode catalytic layer \\ - {i}_{c} , & Cathode catalytic layer \\ 0 , & others\end{matrix} ,$$

wherein: the anode current density is:

iₐ=Aₛj₀^{a}(c_{H}^{m}/c_{H,ref}^{m})^{1/2}[exp(αₐnₐFηₐ/RT)−exp(−α_{c}nₐFηₐ/RT)],

the cathode current density is:

i_{c}=Aₛj₀^{c}(c_{O}^{m}/c_{O,ref}^{m})[−exp(αₐn_{c}Fηₐ/RT)+exp(−α_{c}n_{c}Fη_{c}/RT)],

where cᵢ^{m}=Hᵢρᵢ/Mᵢ;

In the above equations and source items: uᵢ is the component of the gas velocity in the i direction; xᵢ is the coordinate component in the i direction; uⱼ is the gas to velocity component in the j direction; xⱼ is the coordinate component in the j direction; μₑ is an effective viscosity in porous media; ρⱼ is a density of component j; ρ is the gas density; D_{ij,eff} is an effective diffusion coefficient on the i coordinate direction of component j; σₛ is a solid phase conductivity; σₘ is a membrane conductivity; ϕₛ is electric potential; ϕₘ is an ionic potential; μ is a gas viscosity; K is a permeability; M_{H} is a molar mass of hydrogen; M_{O} is a molar mass of oxygen; S_{H} is a hydrogen component source item; S_{O} is an oxygen component source item; Sᵥₐₚₒᵣ is a steam component source item; cᵢ^{m} is a concentration of component i in Nafion; Hᵢ is the Henry constant of component i; Mᵢ is a molar constant in component i; c_{H}^{m} is a concentration of hydrogen in Nafion; c_{H,ref}^{m} is a reference concentration of hydrogen in Nafion; c_{O}^{m} the oxygen concentration in Nafion; c_{O,ref}^{m} is a reference oxygen concentration in Nafion; Aₛj⁰ₐ is an anode reference exchange current density times specific surface area; Aₛj⁰_{c} is a cathode reference exchange current density times specific surface area; nₐ a number of protons transferred by anode electrochemical reaction; n_{c} is a number of protons transferred by cathode electrochemical reaction; αₐ is the anode conversion factor; α_{c} is a cathode conversion factor; β is a water transfer rate; ηₐ is an anode overpotential; η_{c} is a cathode overpotential.

Process similarity analysis of the above equations, and the dimensionless numbers obtained are as follows:

$${Π}_{1} = R e = \frac{ρ ul}{ɛ {μ}_{e}} , \\ {Π}_{2} = E u = \frac{{ɛ}^{2} Δ p}{ρ {u}^{2}} , \\ {Π}_{3} = D a r = \frac{K {μ}_{e}}{ɛ {l}^{2} μ} = \frac{K {μ}_{r}}{ɛ {l}^{2}} , \\ {Π}_{4} = \frac{α n F η}{R T} , \\ {Π}_{5} = Dam = \frac{{H}_{O}}{{n}_{i} F} \frac{{k}_{s , i} {A}_{s} {j}_{c}^{0} {l}^{2}}{{c}_{c , r e f}^{m} D} , \\ {Π}_{6} = \frac{l u}{D} , \\ {Π}_{7} = \frac{{M}_{O} {c}_{O , ref}^{m} {φ}_{i}}{{H}_{O} {A}_{s} {j}_{c}^{0} {ρ}_{O} {l}^{2}} ;$$

Among the above dimensionless numbers: Re is a Reynolds number; μₑ is the effective viscosity in porous medium; Eu is an Euler number; Δp is a pressure drop; μᵣ is a relative viscosity of porous medium; α is a conversion factor; n is the number of protons transported by electrochemical reaction; H_{O} is Henry's constant; k_{s,i} is a coefficient in a chemical equation; nᵢ is the number of electrons transferred per mole of reaction; σᵢ is an i-phase conductivity; ϕᵢ is an i-phase potential; ρ_{O} is a density of oxygen; and the remaining parameters are the same as above.

(6) In the case where the forms of the dimensionless numbers obtained by the two methods are not exactly the same, compare the dimensionless numbers obtained by the dimensional analysis to obtain the relationship between them; for the single phase

isothermal model, the following results are obtained:

$${Π}_{1} = \frac{1}{ɛ {μ}_{r} {π}_{2}} , \\ {Π}_{2} = {ɛ}^{2} {π}_{1} , \\ {Π}_{3} = \frac{{μ}_{r}}{ɛ} {π}_{3} , \\ {Π}_{4} = α n {π}_{4} , \\ {Π}_{5} = \frac{{k}_{s , i} {H}_{O}}{{n}_{i} {π}_{5} {π}_{6}} , {Π}_{6} = \frac{1}{{π}_{5}} , {Π}_{7} = \frac{{π}_{7}}{{H}_{O}} .$$

(7) Define the dimensionless voltage and the dimensionless current density as follows:

$$\overline{V} = \frac{{V}_{o c}}{{V}_{cell}} - 1 , {\overline{J}}_{cell} = \frac{{j}_{cell}}{{j}_{cell , 0}} , {j}_{cell , 0} = \frac{{H}_{O} {A}_{s} {j}_{0} {ρ}_{in , c} {L}_{t}}{{M}_{O} {c}_{0 , r e f}^{m}} ,$$

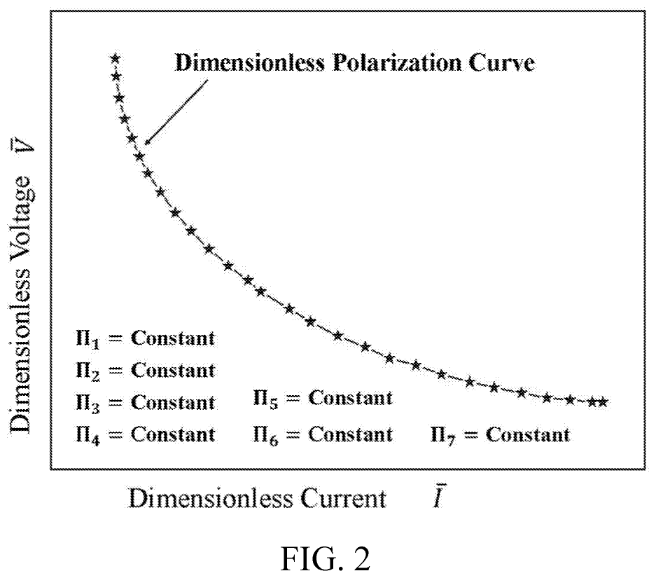

which is used to represent the dimensionless polarization curve, as shown in FIG. 2. Wherein V_{cell} is the output voltage, V_{OC} is the open circuit voltage, j_{cell} is the output current density, j_{cell,0} is the reference output current density, Lₜ is the distance between the cathode and the anode plate, and the rest of the parameters are defined as above.

(8) Change the quantity of each component of the dimensionless number, such as the temperature and pressure, so that the resulting dimensionless number changes, and the resulting dimensionless polarization curve is different from the original one. This proves that the dimensionless polarization curve obtained by the method can reflect the influence of operating conditions on the fuel cell output characteristics.

(9) Change quantity of each component of the dimensionless number so that the value of the dimensionless number changes within a certain range. Thus, a corresponding dimensionless polarization curve (with dimensionless current as the horizontal axis and dimensionless voltage as the vertical axis) is obtained, wherein any point is not just a point, but it represents a group of similar actual engineering condition. For example, for a dimensionless number Π₁, the components are ρ, u, l, ε and μₑ, and these five component quantities are changed arbitrarily, and each change represents an actual working condition (for examples, working condition 1, working condition 2, working condition 3 and working condition 4 can represent the actual working conditions of four projects). As long as the dimensionless number Π₁ remains unchanged (the other dimensionless numbers also remain unchanged), the same dimensionless polarization curve will be obtained, so we call these four working conditions a group of similar actual engineering working conditions. In the stage of numerical simulation and engineering experiment, only one simulation or one experiment is selected for the working conditions of the same dimensionless numbers (any one of the seven dimensionless numbers). That is, for the similar actual engineering working conditions, only one is selected for simulation or engineering experiment. This greatly reduces the number and time of simulation or engineering experiment, and can achieve cost-saving effects. It is of great significance to more efficiently and systematically organize experiments or simulation work in thefuel cell to engineering.

What is claimed is:

1. An analysis method of input and output characteristics of a proton exchange membrane fuel cell, which utilizes π theorem and principle of similarity to carry out dimensional analysis of model parameters and equation analysis of governing equations respectively based on a given numerical model of the proton exchange membrane fuel cell, executed by processor of a computer, comprising the steps of:
(a) determining the model parameters of the numerical model, wherein the model parameters include geometric structure parameters, physical parameters and working condition parameters;
(b) determining dimensions of each of the model parameters of the model and filtering out basic parameters for processing dimensional analysis;
(c) using π theorem to process dimensional analysis for the model parameters to obtain a first set of dimensionless numbers;
(d) using the principle of similarity to process analysis for the governing equations of the numerical model to obtain a second set of dimensionless numbers, wherein the governing equations of the numerical model includes a mass equation, a momentum equation, a component equation, an electric potential equation and an ionic potential equation;
(e) comparing the first set of dimensionless numbers and the second set of dimensionless numbers, processing combination of dimensionless numbers for one of the first set of dimensionless numbers and the second set of dimensionless numbers if needed, determining a relationship between the first and the second sets of dimensionless numbers and verifying an identity of the first and the second sets of dimensionless numbers, and finally determining dimensionless numbers of the numerical model of the proton exchange membrane fuel cell;
(f) defining a dimensionless voltage and a dimensionless current for the numerical model of the proton exchange membrane fuel cell to representing a dimensionless polarization curve for the numerical model of the hydrogen fuel cell.

2. The analysis method of input and output characteristics of the proton exchange membrane fuel cell according to claim 1, wherein the numerical model is a single phase isothermal model of parallel flow channel,
wherein the geometric structure parameters comprise: a dimensional parameter of a characteristic length l of which a unit is m, and a dimensionless parameter of a porosity ε;
the physical parameters comprise: dimensional parameters of density ρ, viscosity μ, permeability K, gas diffusion coefficient D, Faraday constant divided by gas constant F/R of which the units are kg/m³, Pa·s, m², m²s⁻¹, and (C·K)/J respectively; and a dimensionless parameter of the Henry's constant H;
the working condition parameters comprises: dimensional parameters of speed u, temperature T, concentration c, electric potential ϕ, and pressure p, and their units are m/s, K, mol/m⁻³, V, and Pa respectively; and dimensionless parameters of water conversion Coefficient β, cathode transfer coefficient α, stoichiometric ratio St, and mass fraction ω.

3. The analysis method of input and output characteristics of the proton exchange membrane fuel cell according to claim 2, wherein the model parameters further comprise combined parameters, the combined parameters are variables which usually appear in a form of combination and are treated as one parameter for processing dimensional analysis.

4. The analysis method of input and output characteristics of the proton exchange membrane fuel cell according to claim 3, wherein the combined parameters are Faraday constant divided by specific surface area and reference exchange current density F/(Aₛj⁰), conductivity times mole fraction divided by the specific surface area and the reference exchange current density σM/(Aₛj⁰), and their units are m³·s/mol and kg/(V·mol·m²) respectively.

5. The analysis method of input and output characteristics of the proton exchange membrane fuel cell according to claim 4, wherein in the step (b), the dimensions of each of the model parameters are determined as: DIM(L)=L, DIM(ρ)=ML⁻³, DIM(u)=LT⁻¹, DIM(T)=θ, DIM(c)=NL⁻³, DIM(ϕ)=ML²T⁻³I⁻¹, DIM(p)=L⁻¹MT⁻², DIM(μ)=L⁻¹MT⁻¹, DIM(K)=L², DIM(D)=L²T⁻¹, DIM(F/R)=L⁻²M⁻¹T³ΘI, DIM(F/(Aₛj⁰))=L³TN⁻¹, DIM(σM/(Aₛj⁰))=M⁻²T³IN⁻¹; and the filtered basic parameters are: characteristic length L, gas density ρ, gas velocity u, temperature T, gas concentration c, and electric potential ϕ;
in the step (c), the first set of dimensionless numbers obtained are:
$${π}_{1} = \frac{p}{ρ {u}^{2}} , \\ {π}_{2} = \frac{μ}{ρ ul} , \\ {π}_{3} = \frac{K}{{l}^{2}} , \\ {π}_{4} = ( \frac{F}{R} ) \frac{φ}{T} , \\ {π}_{5} = \frac{D}{u l} , \\ {π}_{6} = ( \frac{F}{{A}_{s} j} ) \frac{u c}{l} , and$$
$${π}_{7} = ( \frac{σ M}{{A}_{s} j} ) \frac{c φ}{{l}^{2} ρ} ;$$
in the step (d), the mass equation is:
$$\frac{\partial ( ρ {u}_{i} )}{\partial {x}_{i}} = {S}_{m} ,$$
the momentum equation is:
$$\frac{ρ}{{ɛ}^{2}} {u}_{i} \frac{\partial {u}_{j}}{\partial {x}_{i}} = - \frac{\partial p}{\partial {x}_{j}} + \frac{{μ}_{e}}{ɛ} \frac{\partial }{\partial {x}_{i}} ( \frac{\partial {u}_{j}}{\partial {x}_{i}} ) + {S}_{u , j} ,$$
the component equation is:
$${u}_{i} \frac{\partial {ρ}_{j}}{\partial {x}_{i}} = \frac{\partial }{\partial {x}_{i}} ( {D}_{ij , eff} \frac{\partial {ρ}_{j}}{\partial {x}_{i}} ) + {S}_{j} , j = {H}_{2} , {O}_{2} , vapor ,$$
the electric potential equation is:
∇·(σₛ∇ϕₛ)+S_{ϕ,s}=0; and
the ionic potential equation is:
∇·(σₘ∇ϕₘ)+S_{ϕ,m}=0;
wherein the governing equations comprises a plurality of source terms consisting of:
a mass source item: Sₘ=ΣᵢSᵢ, i=H₂, O₂, H₂O;
a momentum source item:
$${S}_{u , j} = - \frac{μ}{K} {u}_{j} ;$$
component source items:
$${S}_{H} = \{ \begin{matrix}- ( {i}_{a} / 2 F ) {M}_{H} , & Anode catalytic layer \\ 0 , & others\end{matrix} , \\ {S}_{O} = \{ \begin{matrix}- ( {i}_{c} / 4 F ) {M}_{O} , & Anode catalytic layer \\ 0 , & others\end{matrix} , \\ {S}_{v a p o r} = \{ \begin{matrix}- ( β {i}_{a} / F ) {M}_{H} , & Anode catalytic layer \\ [ ( 1 + 2 β ) {i}_{c} / 4 F ] {M}_{O} , & Cathode catalytic layer \\ 0 , & others\end{matrix} ;$$
an electric potential source item:
$${S}_{φ , s} = \{ \begin{matrix}- {i}_{a} , & Anode catalylic layer \\ {i}_{c} , & Cathode catalytic layer \\ 0 , & others\end{matrix} ; and$$
an ionic potential source item:
$${S}_{φ , m} = \{ \begin{matrix}{i}_{a} , & Anode catalytic layer \\ - {i}_{c} , & Cathode catalytic layer \\ 0 , & others\end{matrix} ,$$
wherein an anode current density is:
iₐ=Aₛj₀^{a}(c_{H}^{m}/c_{H,ref}^{m})^{1/2}[exp(αₐnₐFηₐ/RT)−exp(−α_{c}nₐFηₐ/RT)], and
a cathode current density is:
i_{c}=Aₛj₀^{c}(c_{O}^{m}/c_{O,ref}^{m})[−exp(αₐn_{c}Fηₐ/RT)+exp(−α_{c}n_{c}Fη_{c}/RT)],
where cᵢ^{m}=Hᵢρᵢ/Mᵢ;
where in the governing equations and source items, uᵢ is a component of a gas velocity in an i-direction; xᵢ is a coordinate component in the i-direction; uⱼ is a gas velocity component in an j-direction; xⱼ is a coordinate component in the j-direction; μₑ is an effective viscosity in porous media; ρⱼ is a density of component j; ρ is a gas density; D_{ij,}_{_{eff}} is an effective diffusion coefficient on the i coordinate direction of component j; σₛ is a solid phase conductivity; σₘ is a membrane conductivity; ϕₛ is an electric potential; ϕₘ is an ionic potential; μ is a gas viscosity; K is a permeability; M_{H} is a molar mass of hydrogen; M_{O} is a molar mass of oxygen; S_{H} is a hydrogen component source item; S_{O} is an oxygen component source item; Sᵥₐₚₒᵣ is a steam component source item; cᵢ^{m} is a concentration of component i in Nafion; Hᵢ is the Henry constant of component i; Mᵢ is a molar constant in component i; c_{H}^{m} is a concentration of hydrogen in Nafion; c_{H,ref}^{m} is a reference concentration of hydrogen in Nafion; c_{O}^{m} is an oxygen concentration in Nafion; c_{O,ref}^{m} is a reference oxygen concentration in Nafion; Aₛj⁰ₐ is an anode reference exchange current density times specific surface area; Aₛj⁰_{c} is a cathode reference exchange current density times specific surface area; nₐ a number of protons transferred by anode electrochemical reaction; n_{c} is a number of protons transferred by cathode electrochemical reaction; αₐ is an anode conversion factor; α_{c} is a cathode conversion factor; β is a water transfer rate; ηₐ is an anode overpotential; η_{c} is a cathode overpotential;
in the step (d), the second set of dimensionless numbers are:
$${Π}_{1} = R e = \frac{ρ ul}{ɛ {μ}_{e}} , \\ {Π}_{2} = E u = \frac{{ɛ}^{2} Δ p}{ρ {u}^{2}} , \\ {Π}_{3} = D a r = \frac{K {μ}_{e}}{ɛ {l}^{2} μ} = \frac{K {μ}_{r}}{ɛ {l}^{2}} , \\ {Π}_{4} = \frac{α n F η}{R T} , \\ {Π}_{5} = Dam = \frac{{H}_{O}}{{n}_{i} F} \frac{{k}_{s , i} {A}_{s} {j}_{c}^{0} {l}^{2}}{{c}_{c , r e f}^{m} D} , \\ {Π}_{6} = \frac{l u}{D} , \\ {Π}_{7} = \frac{{M}_{O} {c}_{O , ref}^{m} {σ}_{i} {φ}_{i}}{{H}_{O} {A}_{s} {j}_{c}^{0} {ρ}_{O} {l}^{2}} ;$$
where Re is a Reynolds number; μₑ is an effective viscosity in porous medium; Eu is an Euler number; Δp is a pressure drop; μᵣ is a relative viscosity of porous medium; α is a conversion factor; n is the number of protons transported by electrochemical reaction; H_{O} is Henry's constant; k_{s,i} is a coefficient in a chemical equation; nᵢ is a number of electrons transferred per mole of reaction; σᵢ is an i-phase conductivity; ϕᵢ is an i-phase potential; ρ_{O} is a density of oxygen; and the remaining parameters are the same as above;
in the step (e), when the first set of dimensionless numbers and the second set of dimensionless numbers are not completely identical, compare the dimensionless numbers and the obtained relationship between the first and the second sets of dimensionless numbers are:
$${Π}_{1} = \frac{1}{ɛ {μ}_{r} {π}_{2}} , \\ {Π}_{2} = {ɛ}^{2} {π}_{1} , \\ {Π}_{3} = \frac{{μ}_{r}}{ɛ} {π}_{3} , \\ {Π}_{4} = α n {π}_{4} , \\ {Π}_{5} = \frac{{k}_{s , i} {H}_{O}}{{n}_{i} {π}_{5} {π}_{6}} , \\ {Π}_{6} = \frac{1}{{π}_{5}} , \\ {Π}_{7} = \frac{{π}_{7}}{{H}_{O}} .$$
in the step (f), the dimensionless voltage and the dimensionless current density are defined as:
$$\overline{V} = \frac{{V}_{o c}}{{V}_{cell}} - 1 , {\overline{J}}_{cell} = \frac{{j}_{cell}}{{j}_{cell , 0}} , {i}_{cell , 0} = \frac{{H}_{O} {A}_{s} {j}_{0} {ρ}_{in , c} {L}_{t}}{{M}_{O} {c}_{0 , ref}^{m}} ,$$
where V_{cell} is an output voltage, V_{OC} is an open circuit voltage, j_{cell} is an output current density, j_{cell,0} is a reference output current density, Lₜ is a distance between cathode and anode plate.

6. The analysis method of input and output characteristics of the proton exchange membrane fuel cell according to claim 1, after the step (f), further comprising the step of:
(g) changing a quantity of each of the components of the dimensionless numbers so that values of the dimensionless numbers change within a certain ranges, thereby obtaining a corresponding dimensionless polarization curve, wherein any one of the points is not only one single experimental working condition, but represents a similar set of working conditions, thereby a number of experiments and an experiment time are greatly reduced to achieve an effect of cost saving; or
(h) changing a quantity of each of the components of the dimensionless numbers so that the dimensionless numbers are changed and the dimensionless polarization curve is obtained, thereby verifying that the obtained dimensionless polarization curve can reflect an influence of operating conditions on fuel cell output characteristics.

7. The analysis method of input and output characteristics of the proton exchange membrane fuel cell according to claim 5, after the step (f), further comprising the step of:
(g) changing a quantity of each of the components of the dimensionless number so that values of the dimensionless numberschange within a certain ranges, thereby obtaining a corresponding dimensionless polarization curve, wherein any one of the points on the dimensionless polarization curve not only represents one single experimental working condition, but represents a similar set of working conditions, thereby a number of experiments and an experiment timeare greatly reduced to achieve an effect of cost saving; or
(h) changing a quantity of each of the components of the dimensionless number so that the dimensionless numbers are changed and the dimensionless polarization curve is obtained, thereby verifying that the obtained dimensionless polarization curve can reflect an influence of operating conditions on fuel cell output characteristics.

8. The analysis method of input and output characteristics of the proton exchange membrane fuel cell according to claim 1, wherein the dimensionless polarization curve comprises a dimensionless current as a horizontal axis and a dimensionless voltage as a vertical axis.

9. The analysis method of input and output characteristics of the proton exchange membrane fuel cell according to claim 1, wherein the dimensionless polarization curve comprises a dimensionless current as a horizontal axis and a dimensionless voltage as a vertical axis.

10. The analysis method of input and output characteristics of the proton exchange membrane fuel cell according to claim 2, wherein the dimensionless polarization curve comprises a dimensionless current as a horizontal axis and a dimensionless voltage as a vertical axis.

11. The analysis method of input and output characteristics of the proton exchange membrane fuel cell according to claim 3, wherein the dimensionless polarization curve comprises a dimensionless current as a horizontal axis and a dimensionless voltage as a vertical axis.

12. The analysis method of input and output characteristics of the proton exchange membrane fuel cell according to claim 4, wherein the dimensionless polarization curve comprises a dimensionless current as a horizontal axis and a dimensionless voltage as a vertical axis.

13. The analysis method of input and output characteristics of the proton exchange membrane fuel cell according to claim 5, wherein the dimensionless polarization curve comprises a dimensionless current as a horizontal axis and a dimensionless voltage as a vertical axis.

14. The analysis method of input and output characteristics of the proton exchange membrane fuel cell according to claim 6, wherein the dimensionless polarization curve comprises a dimensionless current as a horizontal axis and a dimensionless voltage as a vertical axis.

15. The analysis method of input and output characteristics of the proton exchange membrane fuel cell according to claim 7, wherein the dimensionless polarization curve comprises a dimensionless current as a horizontal axis and a dimensionless voltage as a vertical axis.

16. The analysis method of input and output characteristics of the proton exchange membrane fuel cell according to claim 8, wherein the dimensionless polarization curve comprises a dimensionless current as a horizontal axis and a dimensionless voltage as a vertical axis.
